(19) United States
(12) Patent Application Publication
(10) Pub. No.: US 2017/0216969 A1
(43) Pub. Date: Aug. 3, 2017

(54) METHOD FOR PRODUCING A THERMAL BARRIER COATING ON A COMPONENT

(71) Applicant: Siemens Aktiengesellschaft, München (DE)

(72) Inventors: Jens Dietrich, Falkensee (DE); Jan Münzer, Berlin (DE)

(21) Appl. No.: 15/303,571

(22) PCT Filed: Mar. 26, 2015
(86) PCT No.: PCT/EP2015/056520

§ 371 Date: Oct. 12, 2016

(30) Foreign Application Priority Data
Apr. 25, 2014 (DE) 10 2014 207 789.3

(51) Int. Cl. B23K 26/082; B23K 26/364; F01D 5/28; B23K 26/402; B23K 26/00; B23K 26/352; B23K 26/386; B23K 26/0622

(52) U.S. Cl. CPC B23K 26/082; B23K 26/386; B23K 26/364; B23K 26/0624; B23K 26/402; B23K 26/0084; B23K 26/352; F01D 5/288; B23K 2201/001

(57) ABSTRACT

A method for producing a thermal barrier coating on a component, more particularly on a turbine component and preferably on a turbine blade, wherein the component is provided with the thermal barrier coating and structures are then created in the outer surface of the thermal barrier coating using a laser ablation process so as to segment the surface of the thermal barrier coating, the structures being created in the surface of the thermal barrier coating by an ultrashort pulse laser, more particularly a femtosecond laser is provided.

### CROSS-REFERENCE TO RELATED APPLICATIONS

This application claims priority to PCT Application No. PCT/WP2015/056520, having a filing date of Mar. 26, 2015, based off of German application No. DE 102014207789.3 having a filing date of Apr. 25, 2014, the entire contents of which are hereby incorporated by reference.

### FIELD OF TECHNOLOGY

The following relates to a method for producing a thermal barrier coating on a component, in particular on a turbine component and preferably on a turbine blade, in which the component is provided with the thermal barrier coating and then structures are introduced into the outer surface of the thermal barrier coating by means of a laser ablation method, in order to segment the surface of the thermal barrier coating.

### BACKGROUND

Turbomachines, in particular gas turbine plants, comprise a gas turbine in which a hot gas, which has previously been compressed in a compressor and heated in a combustion chamber, is expanded in order to perform work. For high mass flow rates of the hot gas, and thus high power ranges, gas turbines are designed in the axial-flow manner, wherein the gas turbine consists of multiple blade rings positioned in sequence in the throughflow direction. The blade rings have rotor blades and guide vanes arranged over their circumference, wherein the rotor blades are attached to a rotor and the guide vanes are attached to the casing of the gas turbine.

It is known that the thermodynamic efficiency of turbine plants and in particular gas turbine plants increases with increasing inlet temperature of the hot gas into the gas turbine. However, the thermal loadability of the turbine blades imposes limits on the maximum inlet temperature. Accordingly, there is a need to create turbine blades which possess sufficient mechanical strength for operation of the gas turbine, even under high thermal loads.

Such turbine blades consist of a turbine blade body which is made from a superalloy, in particular a nickel-based or cobalt-based superalloy.

Such a superalloy is characterized by high strength and low tendency to fatigue, and by high mechanical loadability even at high temperatures, in particular at temperatures between 800° C. and 1200° C. In that context, the structure of the superalloy can be microcrystalline, columnar-crystalline in the form of a bundle of crystallites oriented parallel to one another, or single-crystal.

In that context, the superalloy is designed with a view to its relevant mechanical properties, but not with a view to its behavior under loading from the hot gases to which the turbine blade is exposed during operation. In that respect, the turbine blade body is provided with a thermal barrier coating (TBC) system which is provided on the outer surface of the turbine blade body in order to protect the turbine blade body from excessive thermal loading, as well as from corrosion and oxidation due to constituents of the surrounding hot gas. Such a thermal barrier coating system generally comprises a metallic adhesion layer applied to the turbine blade body and a ceramic thermal barrier coating provided thereon. In that context, the adhesion layer consists of a high-temperature corrosion- and oxidation-resistant alloy, in particular an alloy of the type MCrAlY, where M represents one or more of the elements Fe, Ni or Co and Y represents yttrium and/or one or more of the rare earth elements. Such an adhesion layer has the advantage that, in the event of the ceramic thermal barrier coating failing, it still provides protection from corrosion and oxidation.

The thermal barrier coating usually consists of a stabilized or partially stabilized zirconium oxide which is applied by electron beam physical vapor deposition (EB-PVD). Alternatively, the thermal barrier coating can also be applied to the turbine blade body by air-plasma spraying (APS).

In order to further raise the permissible turbine inlet temperature, turbine blades are cooled during operation of the gas turbine. In this context, film cooling represents a very effective and reliable method for cooling highly loaded turbine blades. To do this, cooling air is bled from the compressor and fed into the turbine blades which are provided with internal cooling fluid channels. After internal convective cooling of the material of the turbine blades, the air is guided through the cooling fluid channels to the outer surface of the turbine blade. There, it forms a film which flows along the outer surface of the turbine blade, simultaneously cooling and protecting the blade from the hot flow.

The use of thermal barrier coating systems with a ceramic thermal barrier coating is hampered by the problem that the ceramic material is brittle. Due to this brittleness, it is impossible to entirely exclude the possibility of crack formation in the thermal barrier coating system and spalling of the ceramic during operation. In that scenario, it is possible that the metallic substrate of the ceramic will be revealed and exposed to the hot gas stream. A metallic adhesion layer, if present, will provide a certain degree of protection from oxidation and corrosion, in particular if the adhesion layer consists of an MCrAlY alloy or an aluminide. However, the absence of the thermal insulation means that the adhesion layer will be exposed to extreme thermal loading, and as a result can be expected to fail immediately.

In order to counter this problem, it is known, for example from DE 602 08 274 T2, to produce a thermal barrier coating with a segmented surface in order to improve the properties of the thermal barrier coating associated with resistance to temperature changes.

Specifically, a YAG laser is used to engrave structures into the outer surface of a thermal barrier coating in order to form interruptions in the surface which counteract undesired crack formation due to stresses in the thermal barrier coating.

In addition, U.S. Pat. No. 4,377,371 A teaches the intentional creation of cracks in a ceramic layer deposited by plasma spraying. This involves using a CO₂ CW laser to partially melt the outer surface of the ceramic layer. When the molten regions cool and re-solidify, the shrinkage during solidification of the molten regions causes the formation of a multiplicity of benign micro-cracks in the ceramic layer.

It has been shown that the service life of a thermal barrier coating can be increased by introducing engraving-type structures into the surface of this coating. Nonetheless, the purpose of these efforts is to further increase the service life of thermal barrier coatings.

### SUMMARY

An aspect relates to specifying a method for creating a thermal barrier coating having an increased service life.

This aspect is achieved, in a method according to embodiments of the present invention, in that the structures are introduced into the surface of the thermal barrier coating by means of an ultra-short pulse laser, in particular a femtosecond laser.

Embodiments of the invention use ultra-short pulse lasers to introduce engraving-type structures into the surface of the thermal barrier coating. Ultra-short pulse lasers are to be understood as laser beam sources that emit pulsed laser light with pulse durations in the picosecond and femtosecond range. This encompasses picosecond lasers and femtosecond lasers which are generally modelocked lasers. However, research has also already developed attosecond lasers (where 1000 attoseconds=1 femtosecond). In current parlance, these are also considered ultra-short pulse lasers. In contrast to conventional CO₂ or YAG lasers, ultra-short pulse lasers operate with a lower pulse energy, such that the thermal penetration depth is relatively small. In that context, the pulse durations are shorter than the relaxation time of the ceramic material of the thermal barrier coating. As a result, the ceramic material is not melted when producing the engraving-type structures, as is the case when using CO₂ or YAG lasers, but rather what takes place is cold, melt-free ablation. It has been shown that this can avoid or at least reduce stress formation in the surface of the thermal barrier coating, with a consequent increase in the service life of the thermal barrier coating.

The use of ultra-short pulse lasers has the additional advantage that the ablation for each pass is only several micrometers. It is thus possible to create desired engraving depth with high precision. Equally, structures having at least in part a depth of at least 300 μm, in particular at least 500 μm and preferably greater than 1000 um can be introduced into the surface of the thermal barrier coating.

According to one embodiment of the invention, it is provided that the ultra-short pulse laser has an optics that comprises a galvoscanner or microscanner, in order to deflect the generated laser beam in the desired direction. This makes it possible to obtain high advance rates in the range from a few millimeters/second to well beyond 1000 millimeters/second.

According to an embodiment of the invention, it is provided that, in order to produce a structure/structure line having a given width, the laser beam generated by the ultra-short pulse laser is guided multiple times along a structure line to be created, wherein mutually offset tracks are created in the width direction of the structure. In contrast to the known art, in which the engraving geometry is obtained by broadening the focus of the laser beam, in this embodiment an engraving is produced by means of a track offset. Thus, an engraving is produced by multiple, parallel offset tracks.

Another possibility for setting the track width and/or the track geometry is the wobbling method, in which the advancing movement of the laser beam is overlaid with a deflection movement transverse thereto.

In a manner which is known per se, continuous or discontinuous structures/structure lines can be introduced into the surface of the thermal barrier coating using the method according to embodiments of the invention. In that context, the discontinuous structures can comprise blind micro-bores which are introduced into the surface of the thermal coating with a defined separation, diameter and depth. Equally, the discontinuous structures can comprise V-shaped or U-shaped structures.

Discontinuous engravings of this kind make it possible to achieve maximum spatial coverage while avoiding intersections of engravings and the associated undesirable increase in the engraving depth. However, it is in principle also possible to introduce intersecting structures into the surface of the thermal barrier coating.

The engraved tracks or engraving lines can be of U-shaped cross section. It is however alternatively also possible to create tracks of V-shaped cross section. These can be created, with great precision and with a relatively great depth, by means of the relatively small-volume ablation that takes place when machining using an ultra-short pulse laser.

The drawing shows exemplary embodiments of engraving-type structures that can be produced using the method according to the invention, i.e. by laser ablation using an ultra-short pulse laser.

### BRIEF DESCRIPTION

Some of the embodiments will be described in detail, with refernce to the following figures, wherein like designations denote like members, wherein:

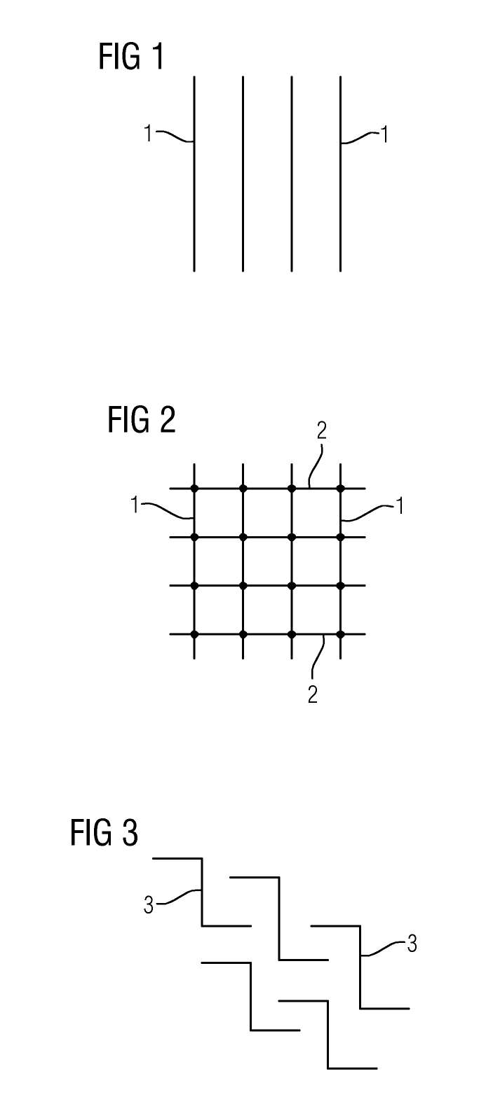

FIG. 1 shows a structure for segmenting the surface of a thermal barrier coating with continuous structure or engraving lines;

FIG. 2 shows an exemplary embodiment of a structure with continuous, intersecting engraving lines;

FIG. 3 shows an exemplary embodiment of a structure for segmenting the surface of a thermal barrier coating with multiple discontinuous engraving lines;

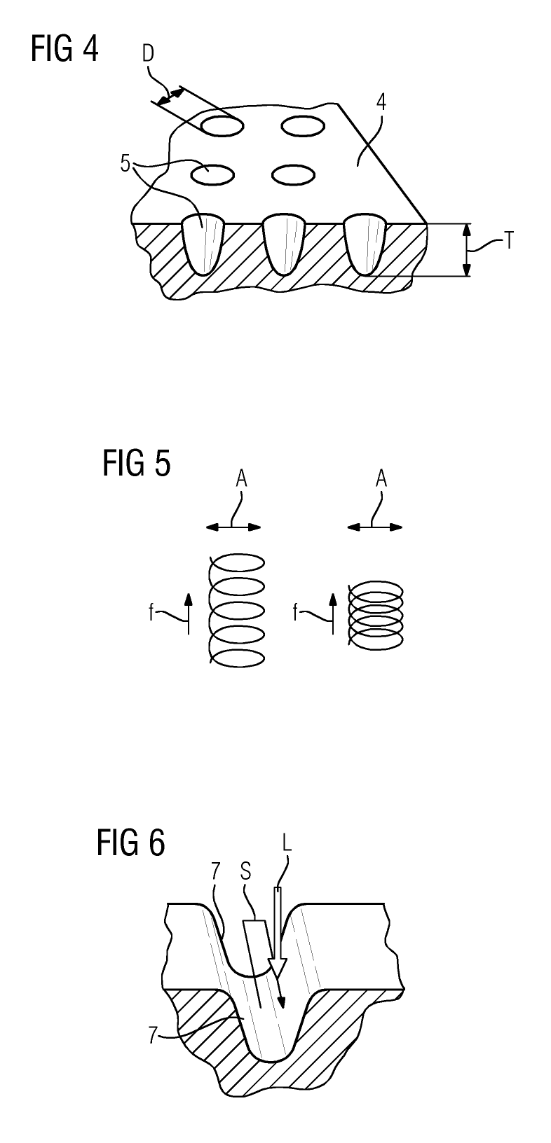

FIG. 4 shows an exemplary embodiment of a structure with blind bores for producing artificial porosity;

FIG. 5 shows an exemplary embodiment of a structure for segmenting the surface of a thermal barrier coating which is created by wobbling; and

FIG. 6 is a schematic diagram showing the scanning movement of a laser beam for creating a broad engraving line.

### DETAILED DESCRIPTION

FIG. 1 shows an example for a structure for segmenting the surface of a thermal barrier coating. In this case, the structure consists of multiple straight, mutually parallel and continuous structure or engraving lines 1. However, the engraving lines 1 may also be sinuous, for example. It is essential that the engraving lines 1 do not intersect.

In the exemplary embodiment of FIG. 2, in addition to the mutually parallel engraving lines 1 of the exemplary embodiment shown in FIG. 1, there are provided engraving lines 2 which run parallel to one another and perpendicular to the lines 1, forming intersection points which create a grid-like engraving line structure.

In the exemplary embodiment of FIG. 3, there are provided multiple Z-like engraving lines 3 which are arranged distributed over the surface of a thermal barrier coating without intersecting. The Z-shaped engraving lines 3 are parallel to one another but positioned offset with respect to one another in the longitudinal and the transverse direction. The arrangement is such that the regions of extent of adjacent Z-shaped engraving lines 3 overlap.

In the exemplary embodiment shown in FIG. 4, structures in the shape of blind bores 5 are provided in the surface of a thermal barrier coating 4 for the purpose of producing artificial porosity, the blind bores having a defined depth T and a defined diameter D.

The exemplary embodiment shown in FIG. 5 demonstrates that engraving lines for producing a desired track width and track geometry can be created by wobbling. In this context, the advancing movement, which is indicated by an arrow f, is overlaid with a deflection movement transverse thereto, which is indicated by a double arrow A. The deflection movement A and possibly also the advancing movement f is/are produced by means of a galvoscanner or microscanner which appropriately deflects the laser beam generated by an ultra-short pulse laser.

Finally, FIG. 6 shows how, in an alternative to wobbling, it is possible to create a wide engraving line 7. Here, a laser beam L is guided multiple times along the engraving line to be created, mutually offset tracks being created in the width direction of the engraving line 7. To that end, the laser beam L is deflected by a suitable galvoscanner or microscanner, as indicated by an arrow S.

Although the invention has been described and illustrated in detail by way of the preferred exemplary embodiment, the invention is not restricted by the disclosed examples and other variations can be derived herefrom by a person skilled in the art without departing from the scope of protection of the invention.

1-10. (canceled)

11. A method for producing a thermal barrier coating on a component, wherein the component is a turbine component and wherein the turbine component is a turbine blade, in which the component is provided with the thermal barrier coating and then structures are introduced into the outer surface of the thermal barrier coating by a laser ablation method, in order to segment the surface of the thermal barrier coating, wherein the structures are introduced into the surface of the thermal barrier coating by an ultra-short pulse laser, wherein the ultra-short pulse laser is a femtosecond laser, and in that the ultra-short pulse laser has an optics that comprises a galvoscanner or microscanner.

12. The method as claimed in claim 11, wherein the wobbling method, in which the advancing movement of the laser beam is overlaid with a movement transverse thereto, is used in order to produce the structures.

13. The method as claimed in claim 11, wherein in order to produce a structure having a given width, the laser beam generated by the ultra-short pulse laser is guided multiple times along a structure line to be created, wherein mutually offset tracks are created in the width direction of the structure.

14. The method as claimed in claim 11, wherein multiple continuous structures are introduced into the surface of the thermal barrier coating.

15. The method as claimed in claim 11, wherein discontinuous structures are introduced into the surface of the thermal barrier coating.

16. The method as claimed in claim 15, wherein the discontinuous structures comprise blind micro-bores which are introduced into the surface of the thermal barrier coating with a defined separation, diameter and depth.

17. The method as claimed in claim 15, wherein the discontinuous structures comprise V-shaped or U-shaped structures.

18. The method as claimed in claim 11, wherein intersecting structures are introduced into the surface of the thermal barrier coating.

19. The method as claimed in claim 11, wherein structures having at least in part a depth of at least 300 μm, are introduced into the surface of the thermal barrier coating.

20. The method as claimed in claim 11, wherein structures having at least in part a depth of at least 500 μm, are introduced into the surface of the thermal barrier coating.

21. The method as claimed in claim 11, wherein structures having at least in part a depth of at least 1000 μm, are introduced into the surface of the thermal barrier coating.
